(19) United States
(12) Patent Application Publication
(10) Pub. No.: US 2008/0135364 A1
(43) Pub. Date: Jun. 12, 2008

(54) Foldable luggage structure

(76) Inventors: Hsien-Wen Chang, Taipei City (TW); Shek-Hing Yu, Hong Kong (CN)

Correspondence Address: Hsieh-Wen Chang, P.O. Box 44 - 2049, Taipei, 10668, omitted

(21) Appl. No.: 11/636,561

(22) Filed: Dec. 11, 2006

(51) Int. Cl. A45C 7/00; A45C 13/30; B62B 1/00

(52) U.S. Cl. 190/103; 190/107; 190/115; 280/37

(57) ABSTRACT

A foldable luggage structure includes a main bag, in which two opposite movable bases are disposed at two sides. Male and female fastener members for fastening the main bag, which is folded one half, are disposed on the main bag near long sides of the main bag. Male and female fastener hooks for hooking the main bag, which is completely folded, are disposed near the outer long sides. Two wheels are disposed at two corners of the main bag. One hand strap has one end fixed to a bottom of the main bag near a middle between the two wheels, and the other end extending upward. The hand strap is fixed and positioned by at least one fixing strap disposed on a backside. Thus, the high mobility and the high convenience can be achieved and the retracted luggage structure occupies less space.

### BACKGROUND OF THE INVENTION

(1) Field of the Invention

The invention relates to an improvement of a luggage structure, and more particularly to a foldable luggage structure having a chamber for accommodating articles, wherein the chamber can be adjusted according to the actual requirement, the foldable luggage structure can be folded to have a minimized volume, and the foldable luggage structure can be carried on the shoulder.

(2) Description of the Prior Art

The luggage that is frequently carried outdoors is mainly composed of a main case and a retractable handle assembly. The main case has one main chamber and attached bags, in which the user may place different kinds of articles. The retractable handle assembly has an L-shape, can be assembled with or disassembled from the main case quickly, and can support the main case. The handle assembly has a vertical portion, which is a retractable rod, and a horizontal portion. Several wheels are disposed on the edge of the horizontal portion so that the luggage can be dragged in a laborsaving manner.

According to the luggage structure, the larger main case can accommodate more kinds and numbers of articles and thus satisfy the diversified requirements of the user and have the good convenience. However, when the luggage structure is not used, it is troublesome to retract the luggage structure, which is large in size.

Although many manufacturers have researched and developed various types of foldable luggage structures, the foldable luggage structures can be partially folded to reduce the volume thereof to a specific level due to the limitation of the structure design of the main case or the retractable handle assembly. Thus, the object and the effectiveness of greatly reducing the size of the luggage structure cannot be really achieved. In view of this, the present invention is to provide a novel foldable luggage structure which may be folded to reduce the size of the luggage structure and thus to satisfy the requirements of the consumers.

### SUMMARY OF THE INVENTION

It is therefore an object of the invention to provide a foldable luggage structure having a chamber for accommodating articles, wherein the chamber can be adjusted according to the actual requirement, and the foldable luggage structure can be completely folded to have a minimized volume and thus can be carried on the shoulder. Thus, the high mobility and the high convenience can be achieved, and the effect of retractable luggage structure without occupying too large space can be achieved.

The invention achieves the above-identified object by providing a foldable luggage structure including a main bag and a hand strap. The main bag is an open hollow bag, in which opposite movable bases are disposed at two sides to support the articles and to prevent the bag from deformation. Opposite big and small storage bags and a fishing net bag are disposed outside the main bag. Male and female fastener members for fastening the main bag, which is folded one half, and male and female fastener hooks for hooking the main bag, which is folded completely, are disposed on the main bag. Also, a retractable shielding cloth is disposed at the inner edge of the opening of the main bag, loops are disposed at four sides of the opening, and a back strap may be selectively connected to any two opposite loops such that the back strap can be carried on the shoulder. Two wheels are disposed at two corners of the main bag so that the main bag may be conveniently moved. One end of the hand strap is fixed to a middle of the bottom between the two wheels, and the other end extends upwards. The hand strap is fixed by fixing straps disposed on a backside of the main bag. A length-adjusting ring for adjusting the length of the hand strap, and a handle are also connected to the hand strap so that the user can drag the main bag in a laborsaving manner. Also, the hand strap extends from the middle of the bottom of the main bag to the outside through the backside so as to provide the good supporting force when the main bag is dragged, and to prevent the bottom and the backside of the main bag from rubbing against the ground. In use, the pulling force applied to the hand strap is converted into the supporting force for supporting the bottom and the backside of the main bag. So, the supporting force becomes greater as the pulling force becomes larger.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is an exploded view showing a luggage structure according to a preferred embodiment of the invention.

FIG. 2 is an exterior view showing the luggage according to the preferred embodiment of the invention.

FIG. 3 is an exterior view showing the luggage according to the preferred embodiment of the invention at another angle of view.

FIG. 4 is a back view showing the luggage structure according to the preferred embodiment of the invention.

FIG. 5 shows a used state of the luggage according to the preferred embodiment of the invention.

FIG. 6 shows another used state of the luggage structure according to the preferred embodiment of the invention.

FIG. 7 shows an operation of folding the luggage structure according to the preferred embodiment of the invention.

FIG. 8 is an exterior view showing the luggage structure, which is completely folded into a flat type according to the preferred embodiment of the invention.

FIG. 9 shows the retracting operations of local units of the luggage structure according to the preferred embodiment of the invention.

### DETAILED DESCRIPTION OF THE PREFERRED EMBODIMENTS

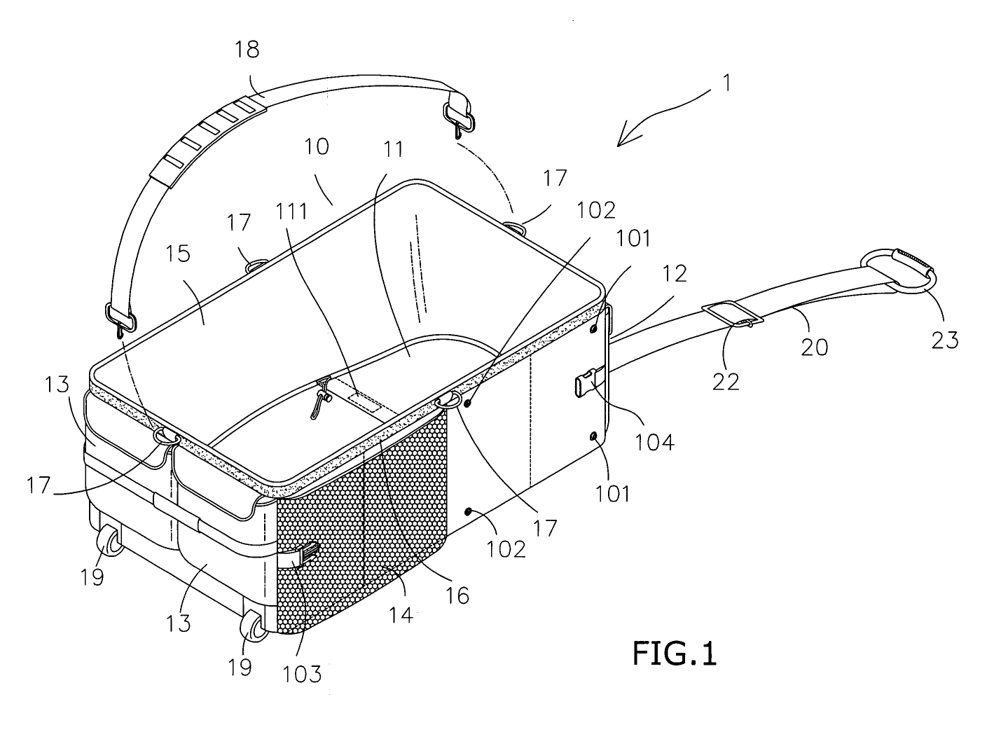

Referring to FIGS. 1 to 4, a foldable luggage structure 1 of the invention includes a main bag 10 and a hand strap 20.

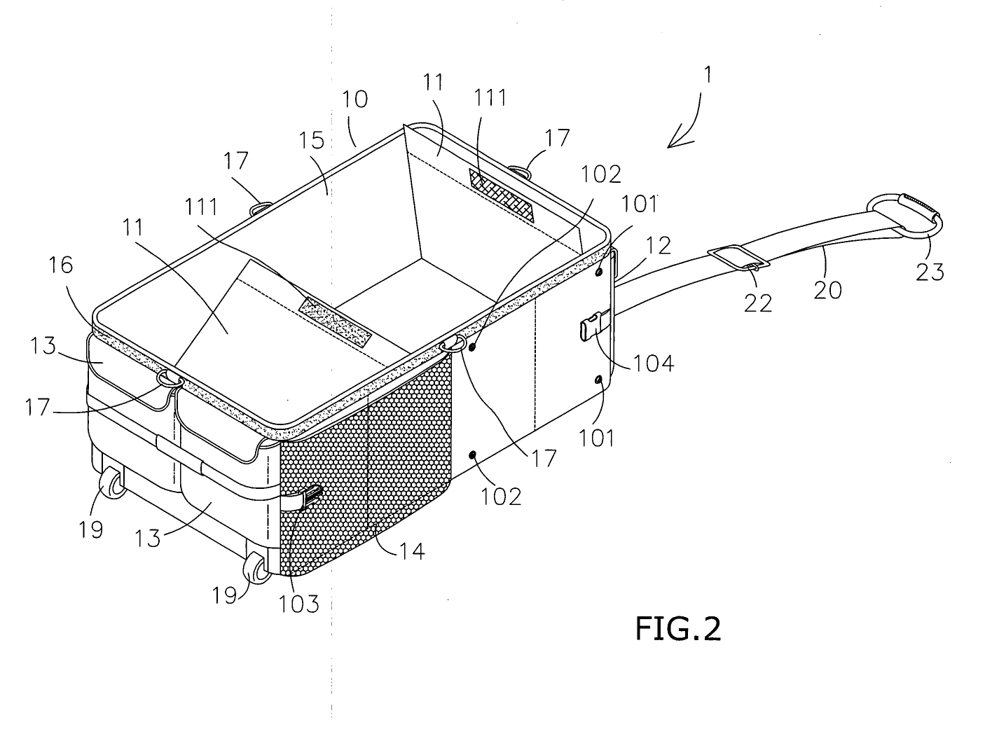

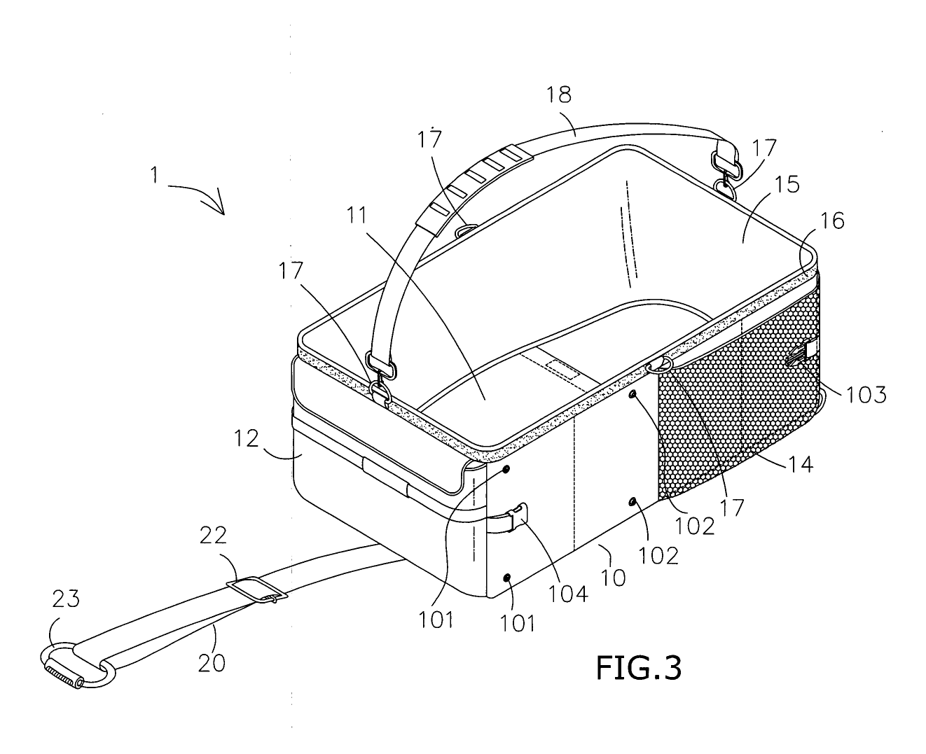

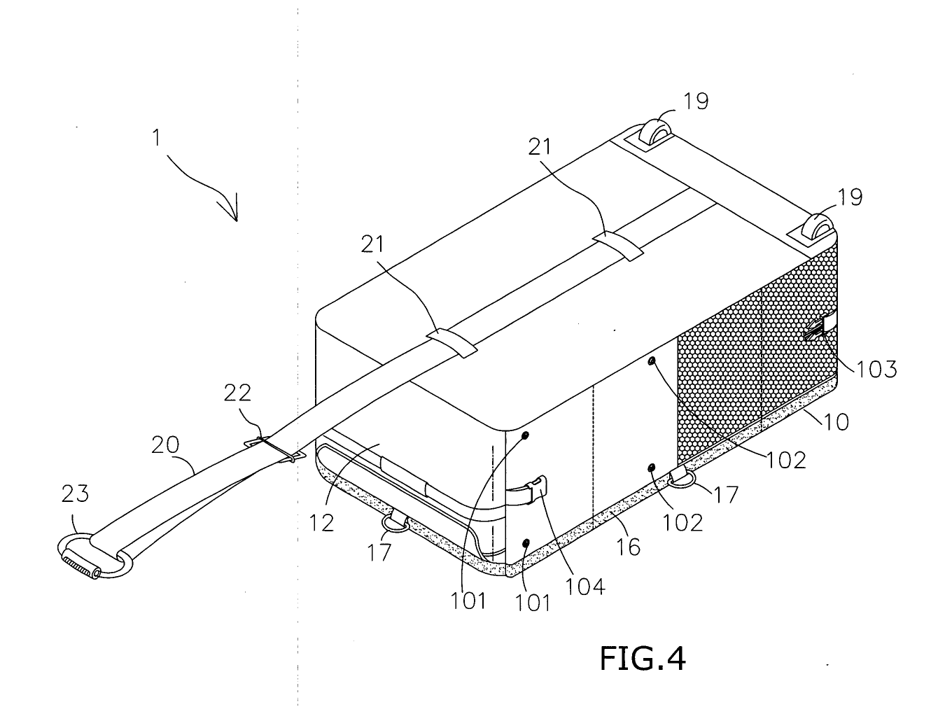

The main bag 10 is an open, rectangular, hollow bag, in which two opposite movable bases 11 are disposed at two sides. Hook-and-loop fastening tapes 111 are respective disposed at adjacent lateral sides of the movable bases 11 in order to enhance the positioning effect, as shown in FIG. 2, to support a placed article, and thus to prevent the bag from deformation. Big and small storage bags 12, 13 are disposed adjacent to short sides of the main bag 10. The big storage bag 12 can accommodate the hand strap 20 or an ice bag, while the small storage bag 13 can accommodate other small articles. A fishing net bag 14 disposed near the outer long side may also accommodate various outdoor articles. Two sets of male and female fastener members 101, 102 are disposed on the main bag 10 to fasten the main bag 10 which is folded one half. One set of male and female fastener hooks 103, 104 for hooking the main bag 10, which is completely folded, is also disposed on the main bag 10 near the outer long sides. Also, a retractable shielding cloth 15 is disposed on an inner edge of the opening of the main bag 10. An adhesive portion 16 is disposed around an outer edge of the opening. Loops 17 are disposed at middles of four sides. A back strap 18 may be selectively hooked to any two opposite loops 17 such that the foldable luggage structure 1 may be carried on the shoulder or may be portable, as shown in FIG. 3. Two wheels are disposed at two corners of the main bag 10 so that the main bag 10 can be conveniently moved, as shown in FIG. 4.

One end of the hand strap 20 is fixed to the bottom of the main bag 10 near a middle between the two wheels 19. The other end of the hand strap 20 extends upward and the hand strap 20 is fixed and positioned by one fixing strap 21 or multiple fixing straps 21 disposed on a backside. A length-adjusting ring 22 for adjusting a length of the hand strap 20 and a handle 23 are connected to the hand strap 20 so that the user may drag the main bag in a laborsaving manner, as shown in FIG. 4. The hand strap 20 extends from the middle of the bottom of the main bag 10 to the backside of the main bag and then extends out so as to provide a better supporting force during dragging and to prevent the bottom and the backside of the main bag 10 from rubbing against the ground during dragging. In use, the pulling force applied to the hand strap 20 is converted into the supporting force for supporting the bottom and the backside of the main bag 10. So, the supporting force becomes larger as the pulling force becomes larger. Also, the handle 23 may be made of an elastic rubber, and the surface of the handle 23 is formed with slip-resistant textures.

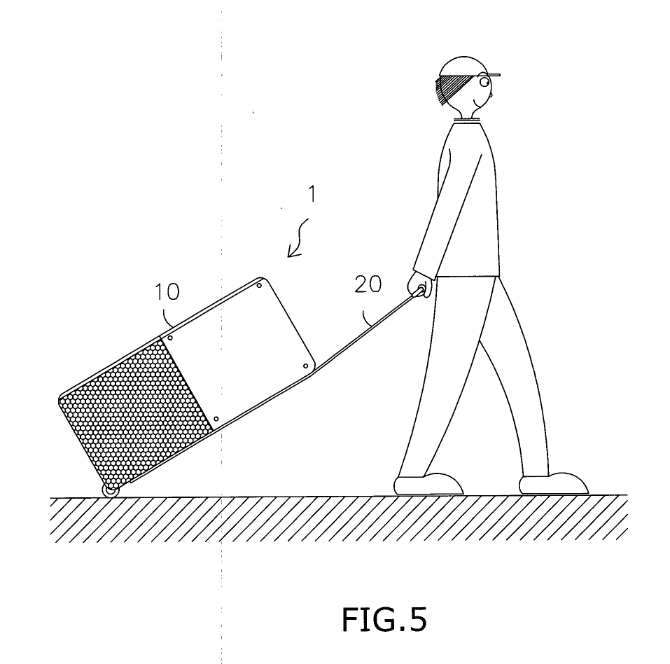

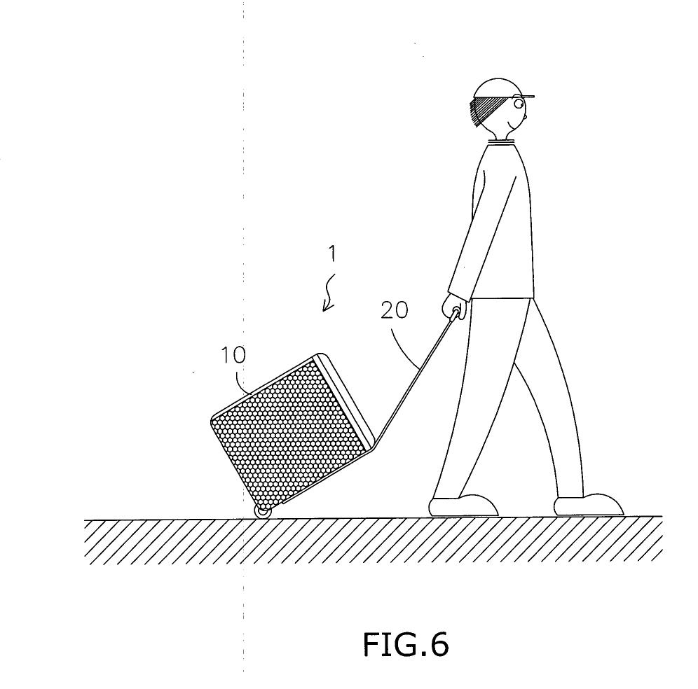

As shown in FIGS. 5 and 6, when the foldable luggage structure 1 is used in practice, the user can adjust the size of the chamber of the main bag 10 according to the traps. The whole main bag 10 or one half of the main bag 10 may be selected, and the hand strap 20 can be used to drag the luggage structure 1 conveniently.

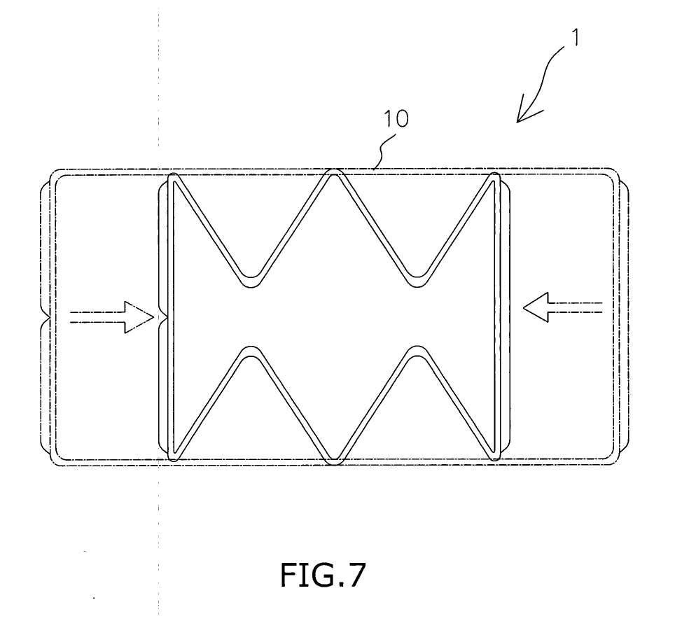

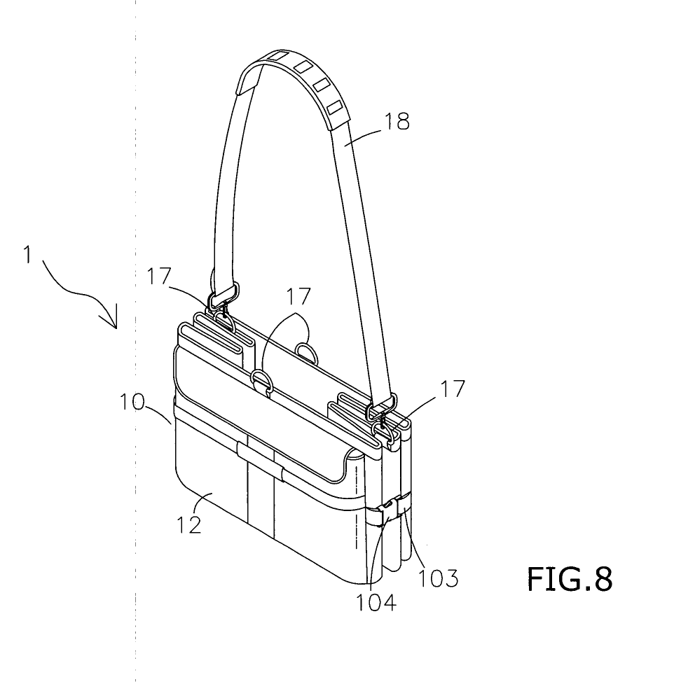

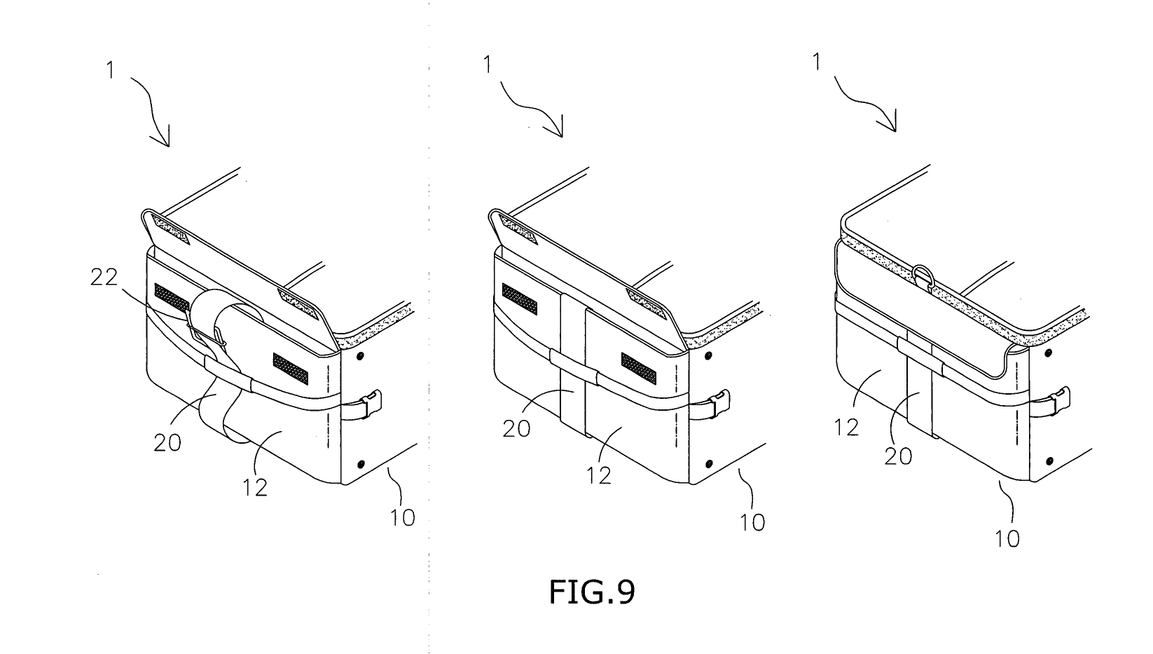

Please refer to FIGS. 7 to 9. FIG. 7 shows the main bag 10, which may folded one half or completely folded. The main bag which is folded one half has the one half chamber of the main bag 10. In practice, one of the movable bases 11 is lifted up to rest against one short side of the main bag 10 in parallel, and the two sets of male and female fastener members 101, 102 near the long sides are fastened together. The completed folded main bag 10 has the minimum size. In practice, the other movable base 11 is lifted up to rest against the other short side of the main bag 10 in parallel, and the main bag 10, which is folded one half, hooks together using the set of the male and female fastener hooks 103, 104 so that the luggage structure 1 is flatten, as shown in FIG. 8. Meanwhile, the back strap 18 is selectively hooked to the two opposite loops 17, such that the back strap 18 can be carried on the shoulder. After the main bag 10 is folded to a minimum and flat pattern, the hand strap 20, the length-adjusting ring 22 and handle 23 may be conveniently retracted into the large storage bag 12 to form the best retracted state.

In summary, the foldable luggage structure has the foldable main bag to effectively achieve the effect of partially or totally reducing the volume of the main bag according to the chamber required by the user in a convenient manner. Also, the hand strap extends from the middle of the bottom of the main bag to the outside through the backside so as to provide the better supporting force when the main bag is dragged. Thus, the bottom and the backside of the main bag are free from rubbing against the ground, and the pulling force applied to the hand strap may be converted into the supporting force for supporting the bottom and the backside of the main bag. So, the supporting force becomes greater as the pulling force becomes greater. The invention can enhance the supporting force of the main bag and minimize the volume of the main bag. Also, the main bag may be carried on the shoulder using the back strap such that the main bag can be carried outdoors and can be retracted conveniently.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A foldable luggage structure, comprising:
a main bag, which is an open hollow bag, in which opposite movable bases are disposed at two sides, wherein opposite male and female fastener members for fastening the main bag, which is folded one half, are disposed near outer long sides, male and female fastener hooks for hooking the main bag, which is completely folded, are disposed near the outer long sides, and two wheels are disposed at two corners of the main bag; and
a hand strap having one end fixed to a bottom of the main bag near a middle between the two wheels, and the other end extending upward from the bottom, wherein the hand strap is fixed and positioned by at least one fixing strap disposed on a backside of the main bag, and a length-adjusting ring and a handle are connected to the hand strap.

2. The foldable luggage structure according to claim 1, further comprising hook-and-loop fastening tapes on adjacent lateral sides of the movable bases.

3. The foldable luggage structure according to claim 1, further comprising opposite big and small storage bags and a fishing net bag disposed outside the main bag.

4. The foldable luggage structure according to claim 1, further comprising a retractable shielding cloth disposed on an inner edge of an opening of the main bag.

5. The foldable luggage structure according to claim 1, further comprising four loops disposed on four sides of an opening of the main bag, and a back strap for selectively connecting any two opposite loops such that the back strap may be carried on a shoulder.

6. The foldable luggage structure according to claim 1, wherein the handle is made of an elastic rubber and a surface of the handle is formed with slip-resistant textures.

7. The foldable luggage structure according to claim 1, further comprising an adhesive portion disposed around an outer edge of an opening of the main bag.
